(19) United States
(12) Patent Application Publication
(10) Pub. No.: US 2006/0109843 A1
(43) Pub. Date: May 25, 2006

(54) Method for information transfer and associated information transfer system

(76) Inventors: Markus Assheuer, Mohrendorf (DE); Ernst Bartsch, Nurnberg (DE); Ramanujam Ramesh, Erlangen (DE)

Correspondence Address: SCHIFF HARDIN, LLP;PATENT DEPARTMENT, 6600 SEARS TOWER, CHICAGO, IL, 60606-6473, US

(21) Appl. No.: 11/271,572

(22) Filed: Nov. 12, 2005

(30) Foreign Application Priority Data
Nov. 12, 2004 (DE) 10 2004 054 742.4

(51) Int. Cl. H04L 12/50

(52) U.S. Cl. 370/379

(57) ABSTRACT

For an efficient exchange of information particularly required for coordination of workflows in a medical or clinical environment, a method for information transmission as well as an associated information transfer system are specified. It is accordingly provided that a message sent from a transmission unit to a reception unit is compared with a number of stored patterns by a scanner unit, whereby, in the case of a positive comparison result, an action associated with the appertaining pattern is initiated.

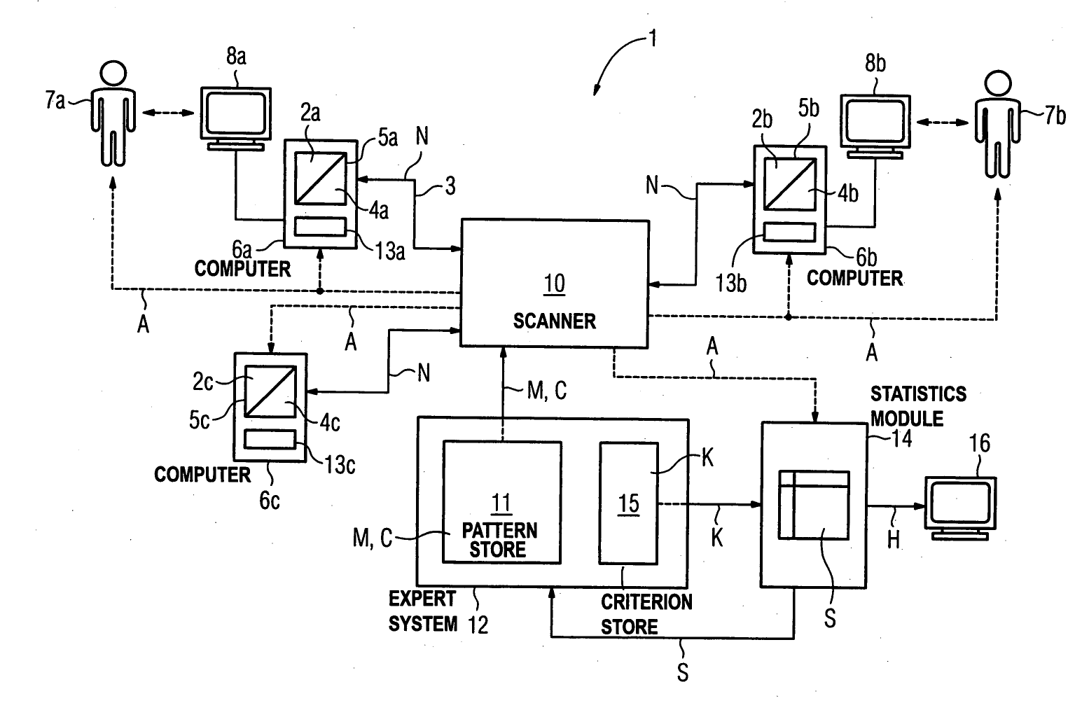

### BACKGROUND

The invention concerns a method for information transfer that is particularly provided for coordinating workflows in a medical or clinical environment. The invention furthermore concerns an information transfer system for implementation of the cited method.

The coordination of workflows in modern clinical operation requires an active and continuous information exchange between the participating personnel groups or data processing systems. The information to be exchanged particularly comprises the scheduling of examinations and therapy sessions and also, if applicable, the reservation of the required apparatus time necessary for this. Furthermore, patient data, examination results, and medical finding reports must be exchanged, meetings must be arranged, and other activities and exchanges must occur.

This coordination traditionally ensues based on paper and/or via oral communication. In addition to these, however, electronic transfer of information are also increasingly used.

E-mail is a medium that is expanding in many areas of daily life—it is simple to operate and is universally usable, and it allows the transfer of text messages and other arbitrary data formats. E-mail communication was previously used only in a limited scope for coordination purposes in the clinical environment. A significant reason for this is that the conventional information transfer via e-mail is too insecure in order to guarantee a smooth coordination of the workflows in medical or clinical operations. Particularly in light of the voluminous amount of, for the most part, irrelevant information transmitted nowadays via e-mail, a noteworthy danger exists that important information is lost in that relevant e-mails are, for example, accidentally deleted or completely overlooked.

### SUMMARY

The invention is based on the object to specify, in front of this background, an effective and simple-to-realize method for information transfer that can in particular be particularly advantageously used for coordination and optimization of workflows in a medical or clinical field. The invention is furthermore based on the object to specify an information transfer system that is particularly suitable for implementation of the cited method.

Accordingly, a method for information transmission, comprises sending a message from a transmission unit to a reception unit; comparing the sent message with a number of stored patterns; and if the comparison is positive, then initiating an action associated with the appertaining pattern.

Similarly, an information transfer system, comprises at least one transmission unit that generates and transmits a message; at least one reception unit that receives the message; and a scanner unit that is switched between said transmission unit and said reception unit, the scanner unit implementing a comparison of the message with a number of stored patterns, a positive comparison result automatically triggering an associated action.

According to an embodiment of the invention, it is provided to compare a message sent from a transmission unit to a reception unit with a number of stored patterns and, in the case of a positive comparison result (i.e., when a coincidence between the tested message and a stored pattern has been established), to automatically initiate an action that is predetermined in association with the appertaining pattern. For this, the information transfer system comprises a scanner unit switched between a transmission unit and a reception unit, which scanner unit is fashioned for analysis of a particular (or every) message sent by the transmission unit to the reception unit as well as for initiation of possible required actions.

The message transmission system is thereby preferably built on the popular e-mail communication mechanism. The at least one transmission unit and the at least one reception unit are particularly components of an SMTP server/client environment. The messages are correspondingly, preferably conventional e-mails. However, the method can also be applied to other workflow messages.

The analysis of the messages ensues via a message pattern comparison. In the simplest (and therefore preferably applied) case, a keyword, a combination of keywords and/or a character format chain is stored as a pattern. A fixed, predetermined sequence of characters, in particular, alphanumeric characters, is stored as a keyword. An example for a keyword is the word “Meeting”. An instruction that defines a specific character format as a search schema without concretely defining the content of a search word is understood as a character format chain.

A general example of a character format chain directed towards the determination of an arbitrary datum is “##.##.####”, whereby the character “#” represents a format identifier for an individual character. It is also possible to provide arbitrary combinations of keywords and character format chains as a pattern. An example for this is the pattern “room R*” which, for example, can be used to determine a room specification from the information content of a message. The character “*” thereby represents a format identifier for an arbitrary number of alphanumeric characters.

The automatic triggering of a communication is particularly provided as an action. The communication alternatively ensues in the form of an alarm message that is generated as a “pop-up” window on a computer screen of a communication receiver, as a reminder message that may be repeatedly generated in predetermined time intervals. Additionally or alternatively, an automatically-generated telephone call or the generation of an SMS etc. can be provided as a communication.

Furthermore, a direct intervention in a workflow is provided as an action. An automatic date entry is particularly effected in the course of such an action. For example, an apparatus time of a medical examination or therapy apparatus requested by the analyzed message is automatically reserved by way of such a date entry, a meeting date is automatically entered into the personal date calendar of the receiver, etc.

In a particularly advantageous embodiment of the invention, it is provided that an entry in an automatically-determined statistic is effected in the course of an action. For example, in this manner statistics are determined about the load of examination and therapy apparatuses, the time expenditure connected with specific work steps, the scheduling of meetings, etc. This statistic is appropriately examined for predetermined criteria of hidden trends. In particular, a conspicuous, time-dependent fluctuation of a statistically-observed quantity is designated as a trend. If, for example, the average transport time of the patients is statistically monitored in this manner, it is particularly detected as a trend when the transport time regularly increases by more than a predetermined threshold at a specific time of day, for example during the middle of the day. Furthermore, a medium- or long-term temporal variation of a statistically-observed quantity, for example, a load of a specific examination apparatus decreasing steadily over a longer period of time, is designated as a trend. If such a trend is detected, a message indicating this trend is generated and output, particularly by a statistic module of the information transfer system.

The automatic analysis of hidden trends described above enables an effective detection of unproductive or faulty structures within a clinic without a noteworthy addition personnel expenditure being incurred for this.

In that this analysis is based on the evaluation of the message exchange of all participating personnel circles and data administration systems of a medical or clinical environment, weak points are also detected that are difficult to detect by a single person due to a complex causal connection with a plurality of different workflows and/or participating persons.

The pattern by which the passing messages are evaluated and the respectively associated actions are preferably stored in a comprehensive expert system. It is optionally provided that this expert system is self-learning, in particular automatically optimized via evaluation of the statistics, in that (for example) non-relevant or no-longer-relevant patterns are automatically erased or modified. Such an optimization in particular occurs using what are known as data mining methods.

### DESCRIPTION OF THE DRAWING

An exemplary embodiment of the invention is subsequently explained in detail using a drawing. The single FIGURE therein shows an information transfer system for use in a medical or clinical environment with a scanner unit switched between a number of transmission units and reception units.

### DETAILED DESCRIPTION OF THE PREFERRED EMBODIMENTS

The information transfer system 1 shown schematically and in a simplified manner in the FIGURE, and according to an embodiment of the invention, comprises a number of transmission units 2a-2c for sending messages N within a data transfer network 3. The system 1 furthermore comprises a number of reception units 4a-4c for reception of the messages N sent over the data transfer network 3.

The system 1 is oriented towards message transmission on the basis of e-mail. The transfer of the messages N in particular ensues using a prevalent Internet transfer protocol, such as SMTP. Each transmission unit 2a-2c is thereby integrated with a respective corresponding reception unit 4a-4c in a client module 5a-5c, which client modules 5a-5c are in turn respectively implemented in a computer 6a-6c of an IT infrastructure of a clinic. This infrastructure in particular comprises workstation computers (the computers 6a and 6b in the shown example) that are directly associated with a user 7a, 7b and communicate with these via associated input/output devices 8a, 8b. The infrastructure furthermore comprises a number of personnel-independent or personnel-spanning computers, such as servers, control computers for examination and therapy apparatuses, etc. For example, the computer 6c is associated with an examination apparatus as a control computer.

The system 1 furthermore comprises a scanner unit 10 that is integrated into the data transfer network 3 such that it has access to the messages N sent by each transmission unit 2a-2c. For this, the scanner unit 10 may be implemented in a central mail server (not shown in detail) of the clinic. Within an arbitrary data transfer path, the scanner unit 10 is thus switched between a sending transmission unit 2a-2c and the respective reception unit 4a-4c provided as the recipient.

The scanner unit 10 serves to analyze the information content of each message M and to effect suitable measures according to the requirements of the analysis result, which measures support the running operating events (workflows) in the clinic. The evaluation of the messages M ensues in that the scanner unit 10 “reads” each passing message N and compares it with a number of predetermined patterns M. The patterns M are provided to the scanner unit 10 from a pattern storage 11 of an expert system 12, meaning a databank in which the necessary background information about the workflows and communication schemata occurring in the clinic is contained in the form of the stored patterns M. Each pattern M comprises one or more keywords and/or character format chains in a specific combination that is characteristic for specific workflows and/or communication schemata. An instruction C for an action A is hereby associated with each pattern M stored in the expert system 12, which action A runs or at least triggers the scanner unit 10 in the event of a positive comparison result. A positive comparison result exists when the scanner unit 10 establishes a congruence between an analyzed message N and a stored pattern M.

The actions A to be effected by the scanner unit 10 comprise as needed communications, direct interventions into workflows and/or monitoring measures.

A communication selectively ensues linked with the workstation via generation of e.g., warning messages and/or reminder messages in the form of “pop-up” windows, warning sounds or the like on the workstation computer 6a, 6b of a user 7a, 7b provided as a communication receiver, or as a direct, person-related communication in the form of an automatically-generated telephone call, an SMS to a mobile telephone of a user 7a, 7b, etc.

A direct intervention into a workflow in particular ensues via automatic appointment allocation in a personal appointment calendar 13a, 13b of a user 7a, 7b, via reservation of apparatus time in the appointment calendar 13c associated with an examination apparatus, etc.

A monitoring measure may ensue via automatic generation of an entry in a statistic S directed in a statistic module 14.

The statistic S is in turn continuously analyzed by the statistic module 14 according to the requirements of a number of criteria K that are provided to the statistic module 14 from a criterion storage 15 of the expert system 12. If, according to the requirements of these criteria K, the statistic module 14 establishes a conspicuous trend of a statistically observed quantity, the statistic module 14 outputs a corresponding indicator H. As shown, this output can directly ensue to an output apparatus 16 of a system administrator or a responsible administration position of the clinic. The output of the indicator H also alternatively ensues via automatic generation of an e-mail, via publication of the indicator H on the intranet, etc. The statistic S is preferably in turn provided to the expert system 12, whereby the latter is fashioned to adapt the stored patterns M and, if applicable, the associated instructions C to the current conditions in a self-learning manner in that, for example, non-relevant or no-longer-relevant patterns M are eliminated or modified, new patterns M are created, etc. The possibility is additionally provided (in a manner not shown in detail) to manually adapt the expert system 12.

The function of the system 1 is subsequently explained below using case examples.

### FIRST CASE EXAMPLE

In a first case example, a first pattern M that contains the combination “((Meeting OR conference) and (R##.##) AND (##.##.20##))” made up of keywords and character format chains is stored in the expert system 12. The character “#” hereby in turn represents the format identifier for a single character. “AND” and “OR” characterize logical links between the individual keywords or character format chains.

If the user 7a now generates a message N addressed to the user 7b with the information content “Meeting on 4 Oct. 2004 at 20:30 in room R2.12”, the scanner unit 10 thus establishes the congruence of the information content of the message N with the first pattern M. The scanner unit 10 thereupon requests the instruction C associated with this pattern M and executes the action A contained in this instruction C.

According to the instruction, this action A comprises the automatic allocation of a corresponding appointment in the personal date planner 13b of a user 7B (provided as a receiver of the message N) with automatic determination of the time, date, and location of the conference from the information content of the message N. The action A furthermore comprises an automatic generation of an SMS to a mobile telephone of the user 7b in order to personally inform him of the date entry. The SMS is thereby only generated when the date entry was effected for the same day. According to the instruction, a corresponding warning message is additionally displayed on the workstation computer 6b of the user 7b in the form of a “pop-up” window.

### SECOND CASE EXAMPLE

In a second case example, a second pattern is stored in the expert system 12, which pattern is specifically directed towards the detection of messages N that are automatically generated by the computer 6c for notification of the beginning or end of each examination session. The instruction C associated with this pattern N contains an action A in the course of which the scanner unit 10 communicates the transmission time and the transmission date of each message corresponding to the pattern M to the statistic module 14 where these data are set down in the statistic S and statistically evaluated. As a criterion K for statistical evaluation, for example, the statistic module 17 receives from the expert system 12 a threshold as a lower desired limit of the load. If the statistic module 14 establishes a repeated under-run of this threshold, the statistic module 14 automatically generates a corresponding notification H.

The advantages achieved with the invention in particular exist in that the risk of an information loss or delayed information receipt in the course of the information exchange necessary for coordination of workflows in the medical (in particular, clinical) environment is significantly reduced, whereby an increased efficiency of these workflows is achieved in turn. This increased efficiency manifests itself on the one hand in a reduced time expenditure for the aforesaid workflows and on the other hand in a reduced risk of a medical error. Embodiments of the invention thereby enablee the use of the e-mail communication that is advantageous under handling-related aspects for coordination of workflows in a medical or clinical environment by preventing the security risks conventionally connected with this. The invention furthermore enables an effective and comparably simple optimization of the workflows via detection of hidden error sources, load fluctuations or other disadvantageous trends.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential ” or “critical”. Numerous modifications and adaptations will be readily apparent to those skilled in this art without departing from the spirit and scope of the present invention.

What is claimed is:

1. A method for information transmission, comprising:
sending a message from a transmission unit to a reception unit;
comparing the sent message with a number of stored patterns; and
if the comparison is positive, then initiating an action associated with the appertaining pattern.

2. The method according to claim 1, wherein at least one pattern comprises a keyword or a combination of keywords.

3. The method according to claim 1, wherein at least one pattern comprises a character format chain.

4. The method according to claim 1, wherein the initiated action comprises sending a communication.

5. The method according to claim 1, wherein the initiated action comprises entering an appointment.

6. The method according to claim 1, wherein the initiated action comprises entering statistical information.

7. The method according to claim 6, further comprising:
examining the statistical information for trends according to predetermined criteria; and
outputting a corresponding indicator if a trend is detected.

8. An information transfer system, comprising:
at least one transmission unit that generates and transmits a message;
at least one reception unit that receives the message; and
a scanner unit that is switched between said transmission unit and said reception unit, the scanner unit implementing a comparison of the message with a number of stored patterns, a positive comparison result automatically triggering an associated action.

9. The system according to claim 8, wherein a pattern comprises a keyword or a combination of keywords.

10. The system according to claim 8, wherein a pattern comprises a character format chain.

11. The system according to claim 8, wherein the action comprises automatically initiating a communication.

12. The system according to claim 8, wherein the action comprises an automatic appointment entry.

13. The system according to claim 8, further comprising:
a statistics module, wherein the action comprises entering statistical information directed by the statistics module.

14. The system according to claim 13, wherein:
The statistics module detects trends within the statistical information according to requirements of predetermined criteria, and outputs a corresponding indicator if a trend is detected.

15. The system according to claim 8, further comprising:
an expert system having a storage area in which the patterns and respectively associated actions are stored.
